(19) United States
(12) Patent Application Publication
(10) Pub. No.: US 2011/0208332 A1
(43) Pub. Date: Aug. 25, 2011

(54) METHOD FOR OPERATING AN ELECTRONIC SOUND GENERATING DEVICE AND FOR GENERATING CONTEXT-DEPENDENT MUSICAL COMPOSITIONS

(76) Inventor: Michael Breidenbrucker, Bizau (AT)

(21) Appl. No.: 13/060,555

(22) PCT Filed: Aug. 26, 2009
(86) PCT No.: PCT/EP09/61021

§ 371 Date: Feb. 24, 2011

(30) Foreign Application Priority Data
Aug. 27, 2008 (DE) 10 2008 039 967.1

(51) Int. Cl. G06F 17/00

(52) U.S. Cl. 700/94

(57) ABSTRACT

Method for operating an electronic sound generating device in which different sound sequences (acoustic output data) for controlling the sound generation device and rules (control commands) for selecting and/or modifying the sound sequences as a function of input signals provided by external sensors are stored, and the sound generation device then selects and/or changes sound sequences depending on the current input data provided by the external sensors and on the rules and then plays the sequences.

### TECHNICAL FIELD

The present invention relates to a method for operating an electronic sound generating device (synthesiser) and for generating corresponding context-dependent musical compositions.

### PRIOR ART

Previously, compositions have been fixed once by the composer and the progression or sound sequence of a piece of music has thus been fixed. Against this background, in relation to the development of the electronics, in particular the development of reproduction devices currently adapted for this purpose, for example those disclosed in the Applicant's German utility model 20 2004 008 347.7, but also for example devices such as the Apple “iPhone”, the object of the present invention is to provide the technical facilities for new compositions in which the composition changes according to rules, predetermined by the composer, relating to particular ambient parameters at the time when the corresponding sound sequence is reproduced, and also to provide the composer with tools for producing and distributing rule systems (compositions) of this type.

### SUMMARY OF THE INVENTION

According to the invention, this object is achieved by a method in which various sound sequences (acoustic output data) for controlling the sound generating device and rules (control commands) for selecting and/or modifying the sound sequences as a function of input signals supplied by external sensors are stored in the sound generating device, and the sound generating device subsequently selects and/or modifies sound sequences, as a function of the input data supplied by the external sensors at the time of the playback and the inputted rules, and then reproduces said sound sequences.

Preferably, microphones, acceleration or movement sensors, light sensors or contact sensors (touchpads) may be used in this context to generate the input data.

The object of the invention is also achieved by a method for generating context-dependent musical compositions in which the composition is provided with a rule system by which, at the time when the composition is played or reproduced, different parts or components of the composition can be selected for reproduction or playing as a function of parameters existing at the time when the composition is played or reproduced.

Preferably, these parameters may be the acoustic analysis of the ambient sounds, the acceleration or movement of a reproduction device, the ambient brightness or mechanical effects on a reproduction device. Moreover, further external parameters can be read in via various interfaces (for example Bluetooth).

Thus far, a composition has always represented a sound sequence which is fixed once and has a fixed progression. The composition would have been fixed at a time in the past and determined by the composer's imagination.

The invention opens up completely new degrees of freedom for the composer. The composer can now work external influences into a composition, and the present invention provides him with the necessary technical means for this for the first time. The actual sound sequence which is reproduced based on the composition is therefore only generated at the time when the composition is reproduced or played back by a correspondingly adapted device, according to the rules created by the composer.

The composer may for example decide that if the ambient sound level increases when the composition is reproduced, instead of a particular first note sequence a particular different note sequence is reproduced. Similarly, the composer could incorporate acoustic responses from the audience, for example if someone in the audience coughs, into his rule system in such a way that for example if someone in the audience coughs a drum roll is played back.

A further highly advantageous possibility of the present invention is for example to give joggers the option of relating the music they hear while running to the speed at which they are running, to the rate of their steps, or even to the corresponding pulse. Thus, if the jogger runs faster or selects a faster step sequence, different music sequences are played back than if he runs more slowly. According to the invention, this could even be based on the jogger's pulse using a type of “biofeedback”. In this way, with a suitable implementation of the method according to a invention, the jogger could be regulated in such a way that he selects an optimally healthy running speed, step frequency or pulse frequency, since only in this way will his background music be reproduced in a subjectively pleasant manner.

With the method according to the invention, musical compositions which are dependent on external influences (ambient sounds, movement, lighting conditions, contacts) can be created and reproduced for the first time. For this purpose, according to the invention, not only is a method for the acoustic reproduction of a note sequence provided, as in the case of a conventional composition, but a rule system is also provided which influences the reproduced note sequences at the time of the playback, or even generates these note sequences in the first place, as a function of the external influences. According to the invention, the form and type of an acoustic reproduction is only generated by the playback device at the time of the playback as a function of external influences (ambient sounds, movement etc.) at the time of the acoustic reproduction, i.e. in real time.

According to the invention, sound-processing devices are controlled in such a way that notes or note sequences are generated, reproduced, modified, recorded or reproduced by these devices in real time at the time of playback, as a function of external influences and the rule system which is provided to the sound-processing device in advance. In this context, corresponding external influences may be movements, types of movement, ambient sound level, type of acoustic environment, ambient brightness, contact with the device (touchpad), etc.

According to the invention, the object of providing the composer with tools for producing and distributing rule systems of this type is achieved in that a program (compiler) is used for compiling the rules (compositions), which program can be adapted to various processors and provides the producers of the rule systems (composers) with a user interface with which the rule systems can easily be produced and stored in an appropriate form (machine code) for the respective sound generating device in a database, from which they are retrieved by users of the sound generating devices as required and loaded onto the user's respective sound generating device.

The rule systems are preferably distributed onto the sound generating devices in this way via the Internet or the mobile telephone network.

### BRIEF DESCRIPTION OF THE DRAWINGS

The sequence of a method according to the invention is explained in greater detail in the following by way of the embodiment shown in the drawings, in which:

FIG. 1 is a program sequence chart for a method according to the invention;

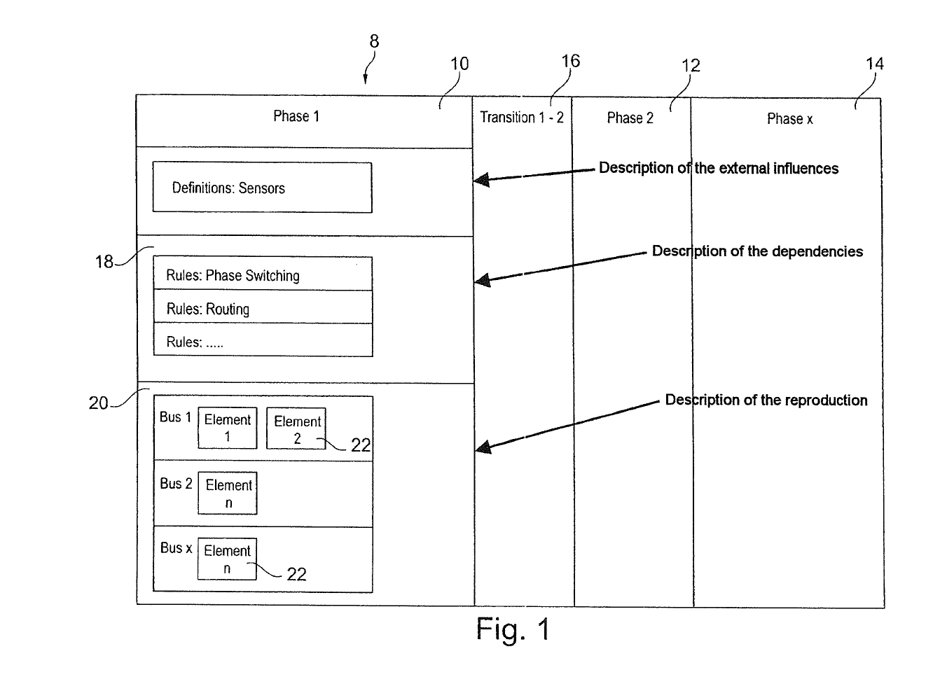

FIG. 2 shows the method according to the invention for producing the rule systems and distributing them onto the users' sound generating devices; and

FIG. 3 is a further schematic representation of the method according to the invention for distributing the rule systems.

### PREFERRED EMBODIMENT OF THE INVENTION

The program sequence chart 8 consists of individual phases 10, 12, 14 and transitions 16 between these phases.

In this context, it is first established in each phase, in this case for phase 10, which input data from which sensors are to be taken into account (definitions: sensors).

A rule system 18 is then provided in advance which can prescribe either the transition into another phase under particular conditions or the reproduction of particular acoustic elements 22 which are described in detail or stored in the array 20. These elements 22 may be tunes or recordings of any sounds (samples) or sound effects which are currently being recorded by a sound input. In this context it is also possible to provide a plurality of channels (bus 1, bus 2 . . . bus x). In this way, the composer can predetermine a plurality of options which the system subsequently selects automatically at the time of the playback on the basis of the rule system 18 and the input data received by the sensors.

The rule system 18 can thus describe the respective dependencies and commands, for example bus 1 plays if the ambient sound level is greater than 60 dB and otherwise bus x plays. However, the rule system 18 may also comprise the instruction to introduce (routing) particular note sequences from the environment into the reproduction elements, with a shift in time or frequency. It is also possible to jump directly to another phase 12, 14, for example if particular acceleration data are present.

Each of these phases 10, 12, 14 may thus have a completely new combination of the components 18, 20 and in each phase the composer can predetermine for the method according to the invention whether the phase is carried out (played) or whether there is a jump to another phase. In each case, this takes place as a function of the input data selected in this regard by the composer for the respective sensors selected by the composer.

The problem remains to be solved of how corresponding rule systems (compositions) or adapted program sequence charts for the sound generating devices are to be produced and stored in the sound generating devices according to user requirements.

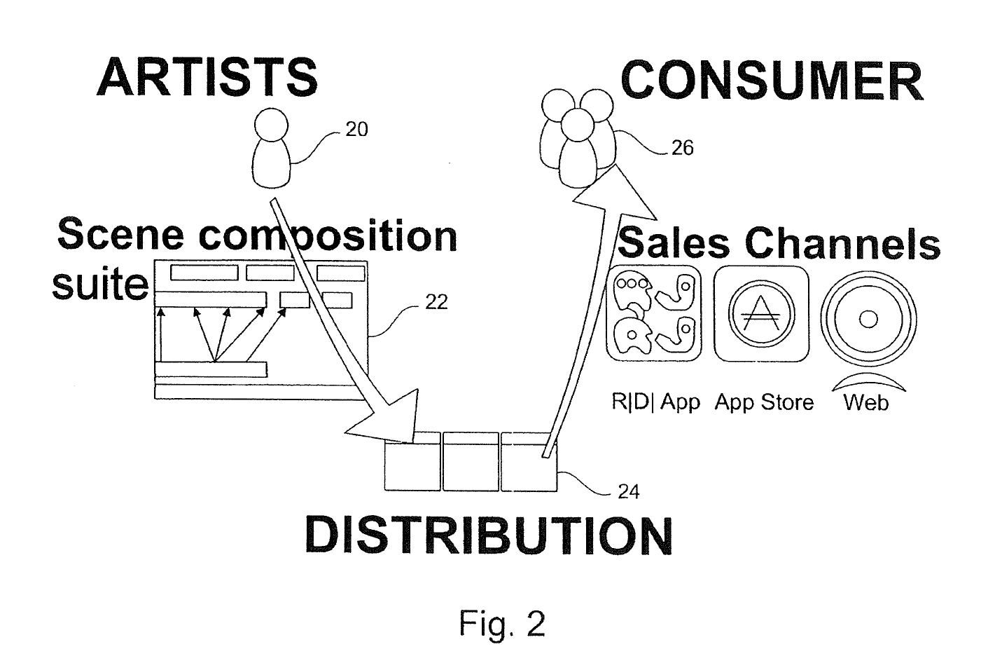

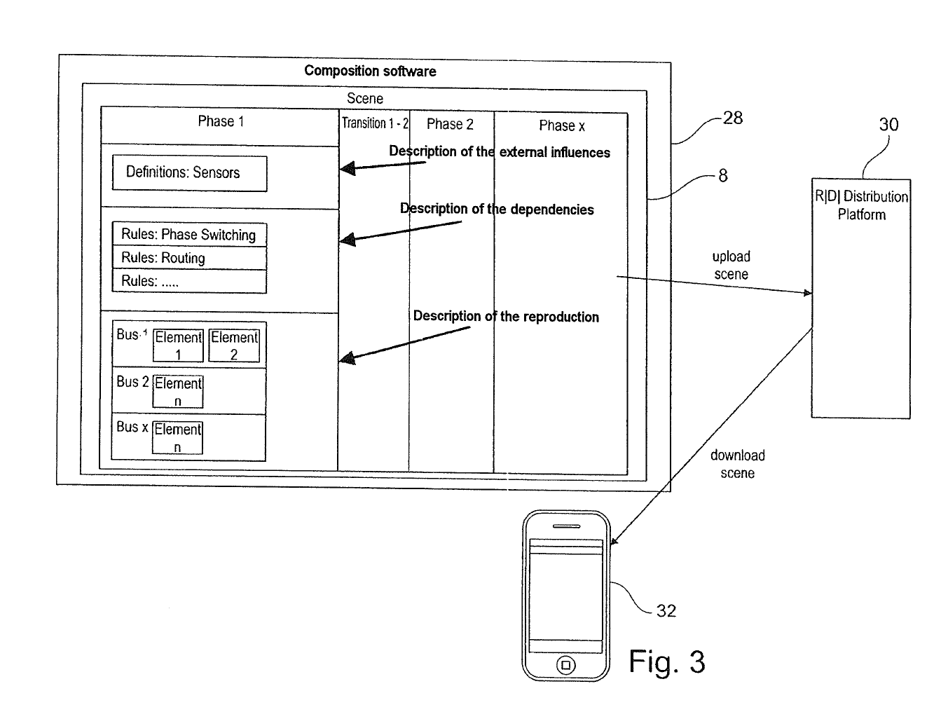

The solution according to the invention to this problem is shown in FIGS. 2 and 3.

FIG. 2 is a general view of the manner of proceeding in this regard.

The composers 20 (denoted here as “artists”) use a program system of editors and compilers 22 (scene composition suite) to produce corresponding program sequence charts 8 or rule systems 18 and convert them into a code (machine code) which can be executed by the respective sound generating device.

Via the Internet or mobile telephone networks 24 (distribution), the corresponding program sequence charts 8 or rule systems 18 are then distributed to the users 26 of the sound generating devices (consumers), in such a way that the users can load the corresponding program sequence charts or rule systems onto their respective sound generating devices.

Since FIG. 2 has explained primarily the organisational sequence of this process, FIG. 3 explains the more technical sequence of this production and distribution of the rule systems for the sound generating devices.

The individual program sequence charts 8 are produced by means of an adapted program system of editors and compilers (composition software) 28 and converted into a code which can be executed by the respective sound generating device. In this context, it should be noted that for different sound generating devices, such as the Apple iPhone, etc., different compilers must naturally also be used in each case, and in this way different translated rule systems must ultimately be provided to the users of the sound generating devices.

For this purpose, a database 30 (RJDJ distribution platform) is provided in which various composers can store their respective rule systems or program sequence charts and from which the individual users can download the rule systems or program sequence charts which are adapted to their respective sound generating device and to their wishes onto their respective sound generating device 32. This downloading process may for example take place via the network or via the mobile communications networks which by now have also been set up for digital data transfer.

1. Method for operating an electronic sound generating device (synthesizer), wherein various sound sequences (acoustic output data) for controlling the sound generating device and rules (control commands) for selecting and/or modifying the sound sequences as a function of input signals supplied by external sensors are stored in a sound generating device, and the sound generating device subsequently selects and/or modifies sound sequences, as a function of the input data currently being supplied by the external sensors and the rules, and then plays back said sound sequences.

2. Method according to claim 1, wherein a microphone for generating the input signals is used as an external sensor.

3. Method according to claim 1, wherein an acceleration or movement sensor for generating the input data is used as an external sensor.

4. Method according to claim 1, wherein a light sensor for generating the input data is used as an external sensor.

5. Method according to claim 1, wherein a contact sensor (touchpad) for generating the input data is used as an external sensor.

6. Method for generating context-dependent musical compositions wherein the compositions are provided with a rule system by which, at the time when these compositions are played or reproduced, different parts or components of the compositions can be selected for reproduction or playing as a function of parameters existing at the time when the compositions are played or reproduced.

7. Method according to claim 6, wherein the parameters comprise the ambient sound level.

8. Method according to claim 6, wherein the parameters comprise the acceleration or movement of a reproduction device.

9. Method according to claim 6, wherein the parameters comprise the ambient brightness.

10. Method according to claim 6, wherein the parameters comprise mechanical effects on a reproduction device.

11. Method according to claim 1, wherein a program (compiler) is used for compiling the rules (compositions), which program can be adapted to various processors and provides the producers of the rule systems (composers) with a user interface with which the rule systems can easily be produced and stored in an appropriate form (machine code) for the respective sound generating device in a database, from which they are retrieved by users of the sound generating devices as required and loaded onto the user's respective sound generating device.

12. Method according to claim 11, wherein the rule systems are retrieved via the Internet.

13. Method according to claim 11, wherein the rule systems are retrieved via the mobile telephone network.
